(19) United States
(12) Patent Application Publication
(10) Pub. No.: US 2025/0072447 A1
(43) Pub. Date: Mar. 6, 2025

(54) CONFECTION AND CONFECTION SET

(71) Applicant: BANDAI CO., LTD., Tokyo (JP)

(72) Inventors: Yuta KATANO, Tokyo (JP); Natsumi FUKUI, Tokyo (JP)

(21) Appl. No.: 18/607,506

(22) Filed: Mar. 17, 2024

(30) Foreign Application Priority Data
Aug. 29, 2023 (JP) 2023-138636
Aug. 29, 2023 (JP) 2023-138645
Aug. 29, 2023 (JP) 2023-139345

(51) Int. Cl. A23G 3/50

(52) U.S. Cl. CPC A23G 3/50; A23G 2220/10

(57) ABSTRACT

The confection includes a start portion, an end portion, and a route portion formed between the start portion and the end portion. The route portion includes: a branch portion at which the route portion is split into multiple route portions, a first route portion extending from the branch portion to the end portion, and a second route portion extending from the branch portion to the end portion. The end portion includes a character portion. The confection includes two or more end portions, as necessary.

### CROSS REFERENCES TO RELATED APPLICATIONS

The present invention contains subject matter related to Japanese Patent Application No. 2023-138645 filed in the Japan Patent Office on Aug. 29, 2023, Japanese Patent Application No. 2023-138636 filed in the Japan Patent Office on Aug. 29, 2023, and Japanese Patent Application No. 2023-139345 filed in the Japan Patent Office on Aug. 29, 2023, the entire contents of which are incorporated herein by reference.

### BACKGROUND OF THE INVENTION

### 1. Field of the Invention

The present invention relates to a confection and a confection set.

### 2. Description of the Related Art

There have been fun confections that consumers can enjoy when eating. For example, Japanese Utility Model Registration No. 3158533 discloses a structure of this type of confection, which includes at least one part made of soft candy and at least one part made of at least one of gummy candy and hard candy. These parts can be attached and assembled together.

Japanese Utility Model Registration No. 3158533 discloses a combination confection in which gummies are dispersed in a soft candy to solve the problem of sticking to teeth. However, the confection disclosed therein has problems in that it requires multiple types of confections and requires different shapes of parts for combination.

### SUMMARY OF THE INVENTION

Accordingly, it is an object of the present invention to provide a fun confection having a simple structure, which does not require multiple types of confections or parts.

A confection according to an embodiment of the invention includes: a start portion; an end portion; and a route portion formed between the start portion and the end portion. The route portion includes a branch portion at which the route portion is split into multiple route portions, a first route portion extending from the branch portion to the end portion, and a second route portion extending from the branch portion to the end portion. The end portion includes a character portion.

A confection according to another embodiment of the invention includes: a start portion; an end portion; and a route portion formed between the start portion and the end portion. The route portion includes a first route portion extending in a first direction, a second route portion extending in a second direction, and a joint portion at which the first route portion and the second route portion are joined at an acute angle.

A confection according to another embodiment of the invention includes: a start portion; an end portion; and a route portion formed between the start portion and the end portion. At least one of the route portion and the end portion includes a plurality of character portions.

The present invention can provide a fun confection.

### BRIEF DESCRIPTION OF THE DRAWINGS

FIG. 1 is a plan view of a confection according to an embodiment of the present invention;

FIG. 2 is a cross-section taken along line II-II in FIG. 1;

FIG. 3 is a cross-section taken along the line III-III in FIG. 1;

FIG. 4A is a cross-section of the confection shown in FIG. 1, taken along line IVA-IVA, and FIG. 4B is a cross-section illustrating a task of peeling a film lid;

FIG. 5 is a perspective view showing an initial state in the play with the confection;

FIG. 6 is a perspective view showing an example state in which the confection has been torn in the play with the confection;

FIG. 7 is a perspective view showing a state in which the confection has not been torn in the play with the confection;

FIG. 8 is a plan view of another form of the confection of the present invention;

FIG. 9 is a plan view of a confection according to another embodiment of the present invention;

FIG. 10 is a cross-section taken along line X-X in FIG. 9;

FIG. 11 is a cross-section taken along line XI-XI in FIG. 9;

FIG. 12 is a cross-section showing an example of how to extract a start portion of the confection;

FIG. 13 is a perspective view showing an example state in which the confection has been torn in the play with the confection;

FIG. 14 is a perspective view showing a state in which the confection has not been torn in the play with the confection;

FIG. 15 is a plan view of a first form of a confection according to another embodiment of the present invention;

FIG. 16 is a plan view of a second form of the confection of the present invention;

FIG. 17 is a plan view of a third form of the confection of the present invention;

FIG. 18 is a plan view of a fourth form of the confection of the present invention;

FIG. 19 is a cross-section taken along line XIX-XIX in FIG. 15;

FIG. 20 is a cross-section taken along line XX-XX in FIG. 15;

FIG. 21 is a cross-section showing an example of how to extract a start portion of the confection;

FIG. 22 is a perspective view showing an example state in which the confection has been torn in the play with the confection; and

FIG. 23 is a perspective view showing a state in which the confection has not been torn in the play with the confection.

### DESCRIPTION OF THE PREFERRED EMBODIMENTS

### First Embodiment

A confection according to an embodiment of the present invention will be described below with reference to the drawings.

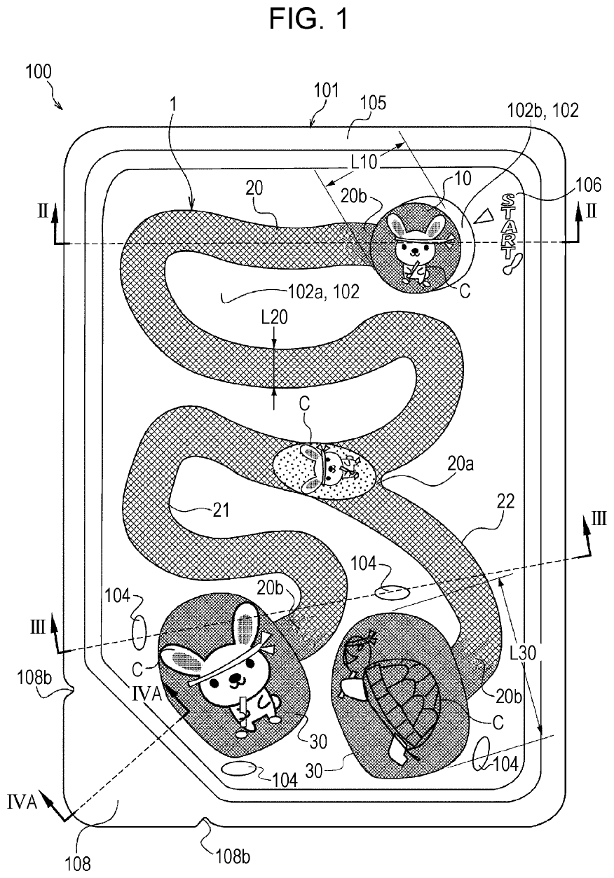

FIG. 1 is a plan view of a confection 1 according to this embodiment.

The confection 1 is a gummy candy. As shown in FIG. 1, the confection 1 and a container 101 accommodating the confection 1 form a confection set 100. When sold, the confection 1 is accommodated in the container 101 shown in FIG. 1 and is further wrapped in decoration wrapper, so that the state shown in FIG. 1 cannot be seen from the outside.

The gummy candies as referred to herein can be made of predetermined amounts of, for example, starch syrup, sugar, gelatin, concentrated fruit juice, edible oil and fat, sorbit, acidulant, thickening agent, plant-derived colorant, and flavoring.

As shown in FIG. 1, the confection 1 has a start portion 10, at which a consumer starts to extract the confection 1 from the container 101, two end portions 30, at which extraction of the confection 1 from the container 101 ends, and a relatively long route portion 20 formed between the start portion 10 and the end portion 30. The route portion 20 includes a branch portion 20a at which the route portion 20 is split into multiple route portions. The route portion 20 includes a first route portion 21 extending from the branch portion 20a to one of the end portions 30, and a second route portion 22 extending from the branch portion 20a to the other of the end portions 30 and shorter than the first route portion 21. The route portion 20 has a constant width in plan view and is curved at multiple locations to have a non-linear shape.

The end portions 30 include character portions C, in which, for example, multiple characters are illustrated as if they are competing in an athletic meet. The two end portions 30 have different character portions C. For example, the end portion 30 on the right side includes a character portion C having a character “tortoise”, and the end portion 30 on the left side includes a character portion C having a character “rabbit”. Another character portion C is provided near the branch portion 20a.

In the confection 1, the end portions 30 have a larger surface area than the start portion 10 to emphasizes the characters who finish in the competition of the athletic meet. The width L20 of the route portion 20 in plan view is smaller than the maximum width L10 of the start portion 10 and the maximum width L30 of the end portions 30.

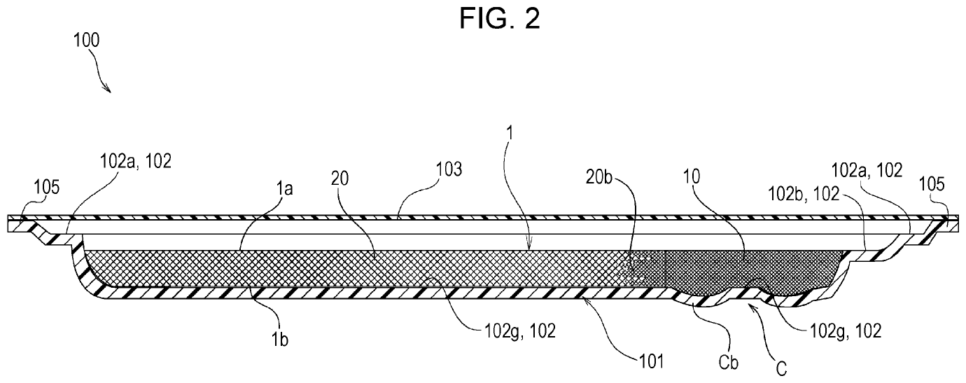

The route portion 20 has a color different from those of the start portion 10 and the end portions 30, and the route portion 20 has a taste different from those of the start portion 10 and the end portion 30. In addition, the portions having different colors are made of different ingredients. Hence, the route portion 20 has the aroma different from the aromas of the start portion 10 and the end portions 30. Furthermore, the colors of the route portion 20, the start portion 10, and the end portions 30 are mixed at connecting portions 20b. Hence, the tastes and aromas are mixed at the connecting portions 20b. FIG. 2 is a cross-section taken along line II-II in FIG. 1.

Although the characters in the character portions C of the confection 1 may be illustrated in multiple colors, in this embodiment, as shown in FIG. 2, the characters are formed with convex-and-concave portions Cb. For example, at the character portions C in the start portion 10 and the end portions 30, an upper side 1a of the confection 1 is a flat surface, whereas a lower side 1b of the confection 1 is a bulging three-dimensional surface (concave/convex surface). So, the convex-and-concave portions Cb are provided at a deepest surface 102g of a bottom surface 102 of the container 101. The features of the character portions C are illustrated with the convex-and-concave portions Cb.

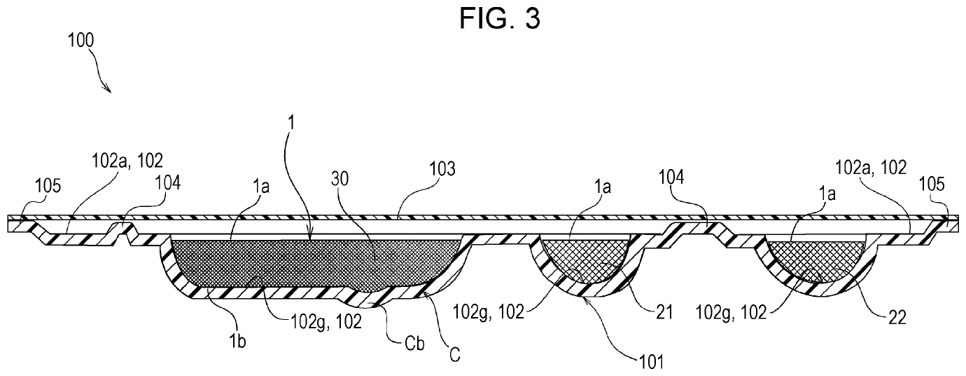

FIG. 3 is a cross-section taken along line III-III in FIG. 1.

As shown in FIG. 3, in the route portion 20 in cross-section, the upper side 1a, which is one side of the confection 1, is a flat surface, whereas the lower side 1b, which is the other side of the confection 1, is a curved surface (see the first route portion 21 and the second route portion 22 in FIG. 3).

The confection 1, which is a gummy candy made of the above-described ingredients, adheres to the deepest surface 102g of the bottom surface 102 of the container 101 at all of the start portion 10, the end portions 30, and the route portion 20, in a state of being accommodated in the container 101. Furthermore, the start portion 10, the end portions 30, and the route portion 20 are all stretchable. Because the confection 1 is adhered to the deepest surface 102g of the container 101, the task of extracting the confection 1 from the container 101 is difficult, as described below. Thus, the consumer can enjoy the difficulty.

Meanwhile, the upper side 1a of the confection 1 is formed so as not to adhere to the bottom surface 102 of the container 101 or a film lid 103. For example, at the start portion 10, the end portions 30, and the route portion 20, the upper side 1a of the confection 1 is positioned below an upper bottom surface 102a, which is the shallowest portion of the bottom surface 102.

An outer peripheral edge 105 of the container 101 stands upright from the upper bottom surface 102a. The film lid 103 is bonded to an upper end face of the outer peripheral edge 105, at a position away from the upper bottom surface 102a in the upward direction, so as not to be in contact with the upper side 1a.

Furthermore, projections 104 (see FIG. 1) higher than the upper bottom surface 102a and extending almost to the film lid 103 are provided on the bottom surface 102 of the container 101, at least near the end portions 30. The projections 104 are provided, for example, around the end portions 30 (see FIG. 1). This configuration makes the film lid 103 less likely to touch the upper side 1a.

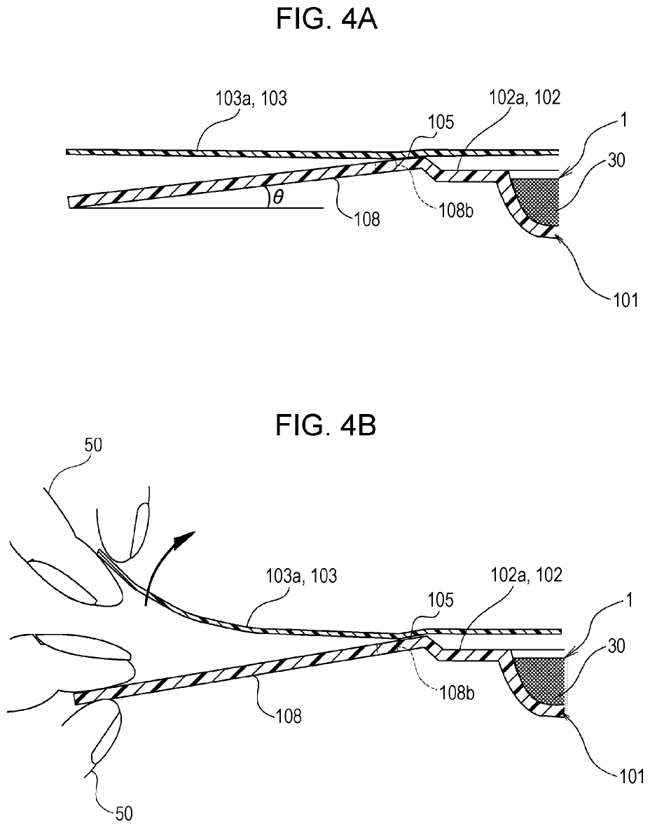

FIG. 4A is a cross-section of the confection 1 shown in FIG. 1, taken along line IVA-IVA, and FIG. 4B is a cross-section illustrating the task of peeling the film lid.

The film lid 103 is bonded to the entire outer peripheral edge 105 of the container 101 accommodating the confection 1. The container 101 has, at the outer peripheral edge thereof, a film peeling portion 108 from which the consumer starts to peel away the film lid 103. The film peeling portion 108 is provided at one corner of the rectangular container 101 in plan view (see FIG. 1). The film peeling portion 108 is provided with a pair of notches 108b at the base end thereof to implicitly indicate that the film lid 103 can be peeled from there. At the film peeling portion 108, the film lid 103 is bonded to the outer peripheral edge 105 along the base end of the film peeling portion 108, and the remainder of the film lid 103, which is not bonded to the outer peripheral edge 105, serves as a facing portion 103a that faces the film peeling portion 108.

Because the film peeling portion 108 has the notches 108b, the film peeling portion 108 is easily deformed. Furthermore, as shown in FIG. 4A, the film peeling portion 108 is inclined (at an angle θ) in a direction (downward in FIG. 4A) away from the film lid 103.

With this configuration, when the consumer opens the container 101, he/she can peel away the film lid 103 by pinching the facing portion 103a, which is a film end, with fingers of one hand and pinching the film peeling portion 108 with fingers of the other hand, as shown in FIG. 4B, for example.

The task of extracting the confection 1 will be described below.

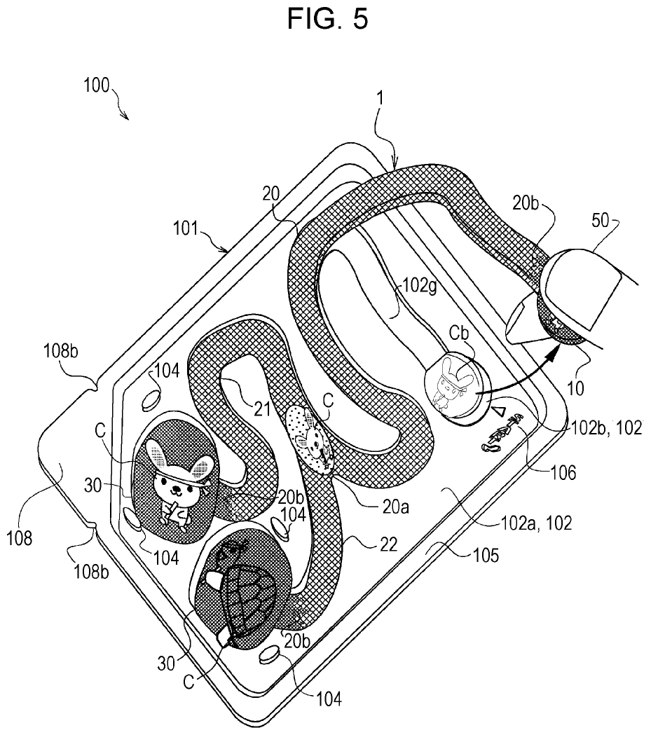

FIG. 5 is a perspective view showing an initial state in the play with the confection 1.

After the film lid 103 is removed, the consumer extracts the confection 1, starting from the start portion 10 indicated by a start mark 106, as shown in FIG. 5. The start portion 10 is provided with an intermediate bottom surface 102a, which is lower than the upper bottom surface 102b (see FIG. 2), to allow a fingertip to easily access the start portion 10.

Then, the consumer lifts the confection 1 accommodated in the container 101 in a state in which the start portion 10, the end portions 30, and the route portion 20 are contracted, by pinching the start portion 10 with fingertips. By doing so, the consumer can extract the confection 1 that is being stretched. At this time, the confection 1 is separated from the container 101 in the order of the start portion 10, the route portion 20, and the end portions 30. Because the confection 1 is in contact with the container 101 at the large and bulging lower side 1b, the confection 1 has high adhesion. Furthermore, because the route portion 20 has a smaller width than the start portion 10 and the end portions 30, the route portion 20 can be stretched more than the start portion 10 and the end portions 30.

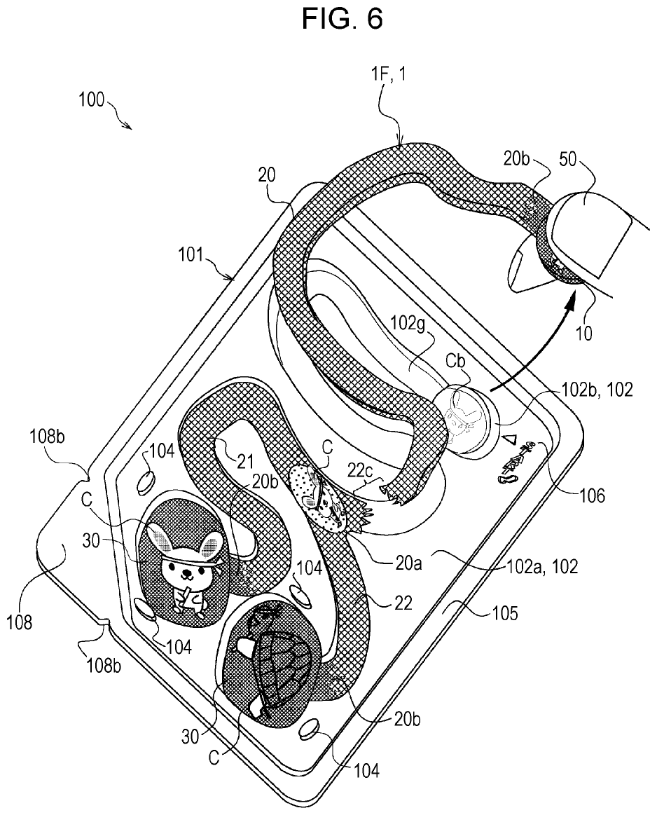

FIG. 6 is a perspective view showing an example of a first state 1F, in which the confection 1 has been torn in the play with the confection 1.

The confection 1 is formed such that it can be torn at any part when stretched to or beyond a certain length. When the confection 1 is separated from the container 101, the confection 1 can be torn at any of the start portion 10, the end portions 30, and the route portion 20. In the case shown in FIG. 6, for example, the confection 1 is torn at a portion 22c upstream of the branch portion 20a. This is because the branch portion 20a, where the first route portion 21 and the second route portion 22 are connected, has higher adhesion than the route portion 20 upstream thereof. In addition, because the peeling direction differs between the first and second route portions, peeling is difficult.

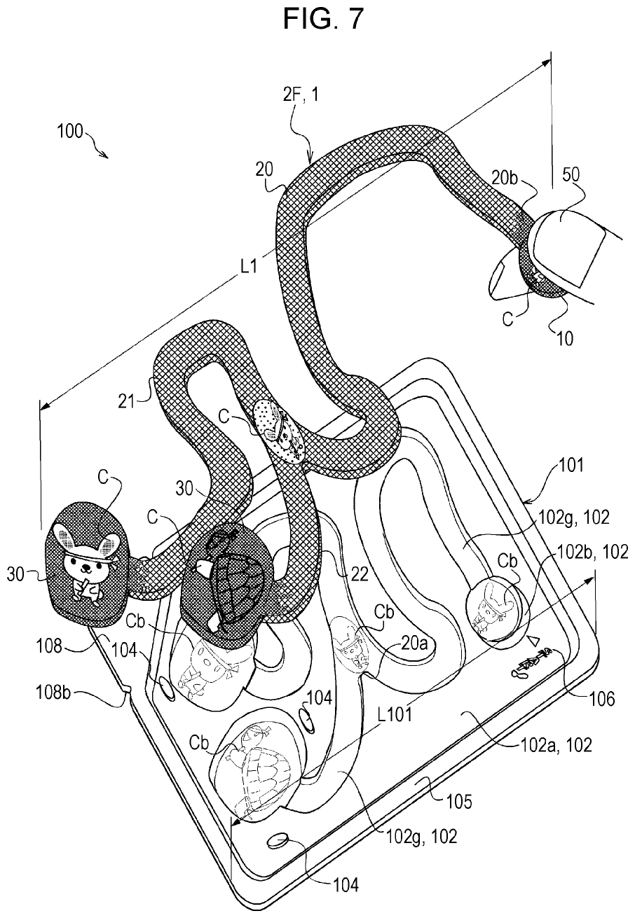

FIG. 7 is a perspective view showing a second state 2F, in which the confection 1 has not been torn in the play with the confection 1.

In the second state 2F shown in FIG. 7, the confection 1 has been successfully lifted without being torn at any part. In this case, the consumer advances peeling while managing to successfully peel the branch portion 20a. At this time, the end portion 30 continuous with the second route portion 22, which is shorter, is peeled slightly earlier than the other end portion 30. For example, the end portion 30 that is peeled earlier may have a character “tortoise”, and the end portion 30 that is peeled later may have a character “rabbit”, so that the consumer can enjoy a competition between the rabbit and the tortoise.

As shown in FIG. 7, the length (L1) of the confection 1 from the start portion 10 to the end portion 30 in a stretched state is larger than the length (L101) of the long sides of the container 101.

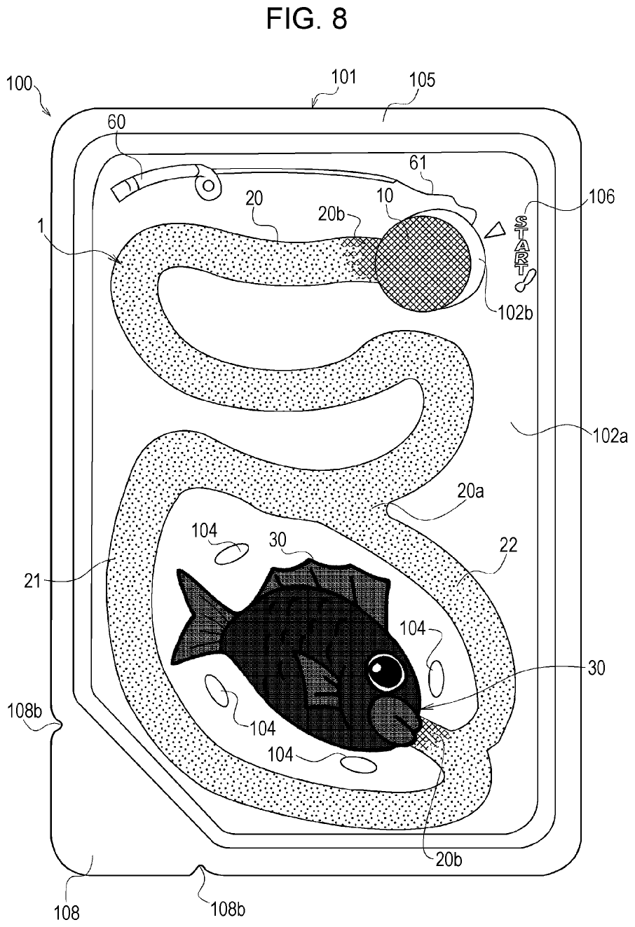

FIG. 8 is a plan view of another form of the confection 1 of the present invention.

In the form shown in FIG. 8, the confection 1 has one end portion 30 including one character portion C. In this case, the first route portion 21 and the second route portion 22 split at the branch portion 20a lead to the same end portion 30. That is, the first route portion 21 and the second route portion 22, which differ in length, join at a portion upstream of the end portion 30.

The character portion C at the end portion 30 in this embodiment is in the shape of fish. A fishing rod 60 is illustrated near the start portion 10, and a fishing line 61 extending from the fishing rod 60 is illustrated so as to lead to the vicinity of the start mark 106 near the start portion 10. With this configuration, the consumer can enjoy the first state 1F, in which fishing is unsuccessful (the confection 1 has been torn), and the second state 2F, in which fishing is successful (all of the start portion 10, the route portion 20, and the end portion 30 have been successfully peeled).

As described above, in the confection 1 according to this embodiment, in the form of a confection set 100 in which the confection 1 is accommodated in the container 101, the start portion 10 and the end portion 30 are connected by the route portion 20, and the route portion 20 is split into multiple route portions at the branch portion 20a. Thus, the consumer can enjoy the process of reaching the character portion C at the end portion 30 via different routes.

In the confection 1 according to this embodiment, if there are two or more end portions 30, the end portions 30 include different shapes of character portions C. Thus, the consumer can enjoy different characters for different routes.

In the confection 1 according to this embodiment, the first route portion 21 and the second route portion 22 differ in length. Hence, the consumer can enjoy different ways of reaching the end portions 30. In particular, because the confection 1 is stretchable and the route portion 20 can be stretched more than the other portions, the consumer can enjoy how the route portion 20 is stretched when he/she peels away the confection 1 from the container 101.

Furthermore, because the route portion 20 has a constant width that is smaller than the widths of the start portion 10 and the end portions 30, the route portion 20 is stretched easily. Thus, the consumer can enjoy stretching the route portion 20 to a great extent.

In the confection 1 according to this embodiment, the end portion 30 has a larger area than the start portion 10 in plan view. Thus, it is possible to emphasize the character portion C at the end portion 30. Furthermore, by making the colors of the start portion 10 and the end portion 30 different from the color of the route portion 20, it is possible to emphasize the end portion 30 and the start portion 10.

In the confection 1 according to this embodiment, the colors of the route portion 20, the start portion 10, and the end portion 30 are mixed at the connecting portions 20b. Thus, the consumer can enjoy the mixture of colors. Furthermore, in the confection 1, when portions having different colors have different tastes, the consumer can enjoy the mixture of tastes at the connecting portions 20b. Furthermore, when portions having different colors have different aromas, the consumer can enjoy the mixture of aromas at the connecting portions 20b.

Because the color, taste, and aroma of the route portion 20 are different from those of the start portion 10 and the end portion 30, the consumer can enjoy the color, taste, and aroma corresponding to each of the route portion 20, the start portion 10, and the end portion 30. In particular, the consumer can enjoy the color, taste, and aroma associated with the character at the end portion 30.

In the confection set 100 according to this embodiment, the route portion 20 is accommodated in the container 101 in a non-linear state. Thus, it is possible to enjoy the difficulty in separating the route portion 20 from the bottom surface 102.

In the confection set 100 according to this embodiment, in the route portion 20 in cross-section, the upper side 1a of the confection 1 is a flat surface, whereas the lower side 1b of the confection 1 is a curved surface. Thus, for example, the contact area between the confection 1 and the deepest surface 102g of the container 101 can be easily changed. This makes it possible to change the adhesion of the confection 1 to the container 101.

In the confection set 100 according to this embodiment, in the start portion 10, the end portion 30, and the route portion 20, the upper side 1a of the confection 1 is formed so as not to adhere to the container 101. Thus, the consumer can lift the confection 1 from the container 101, from the upper side 1a. Furthermore, all the portions (the start portion 10, the end portion 30, and the route portion 20) of the confection 1 are accommodated in the container 101 in a contracted state. Thus, when the confection 1 is separated from the container 101, these portions are stretched due to the adhesion of the confection 1.

In the confection set 100 according to this embodiment, the container 101 is provided with the film lid 103 that can open and close the container 101 without coming into contact with the confection 1. Thus, the confection 1 can be protected without adhering to the film lid 103. Furthermore, the projections 104 higher than the confection 1 are provided on the bottom surface 102 of the container 101, at least near the end portion 30. Thus, contact between the film lid 103 and the upper side 1a of the confection 1 is avoided. In particular, even when the film lid 103 is removed, because the projections 104 effectively prevents the contact between the film lid 103 and the confection 1, it is possible to prevent the confection 1 from adhering to the film lid 103 and being separated from the bottom surface 102 when the film lid 103 is removed.

In the confection set 100 according to this embodiment, the length (L1) of the confection 1 from the start portion 10 to the end portion 30 in a stretched state is larger than the length (L101) of the long sides of the container 101. As a result, when the confection 1 is pulled out, starting from the start portion 10, through the route portion 20, to the character portion C at the end portion 30, the confection 1 can be made to look larger than the size of the container 101. Furthermore, the consumer can feel like as if he/she is extracting the character portion C.

In the confection set 100 according to this embodiment, the confection 1 is formed such that it can be torn at any of the start portion 10, the end portion 30, and the route portion 20. Thus, the consumer can enjoy either the first state 1F, in which the confection 1 has been torn when separated from the bottom surface 102 (failure in extraction), or the second state 2F, in which the confection 1 has not been torn (success in extraction).

Furthermore, in the confection set 100 according to this embodiment, the film lid 103 has the facing portion 103a that is not bonded to the outer peripheral edge 105, and the container 101 has the film peeling portion 108 that is inclined in a direction away from the film lid 103. Hence, when the consumer peels away the film lid 103, he/she can easily pinch and peel away the film lid 103.

Although one embodiment of the present invention has been described above, the present invention can be modified as appropriate within the technical scope thereof. For example, although the confection 1 has two route portions (the first route portion 21 and the second route portion 22) in the above embodiment, the confection 1 may have three or more route portions.

In the above embodiment, the start portion 10 and the end portion 30 have a substantially circular or elliptical shape in plan view. However, the shapes of the start portion 10 and the end portion 30 are not limited thereto. The characters are not limited to those shown in the drawings.

In the above embodiment, the projections 104 are provided so as to surround the end portion 30. However, the positions of the projections 104 are not limited thereto, and the projections 104 may be provided at positions close to the start portion 10 and the route portion 20, for example.

### Second Embodiment

A confection according to an embodiment of the present invention will be described below with reference to the drawings.

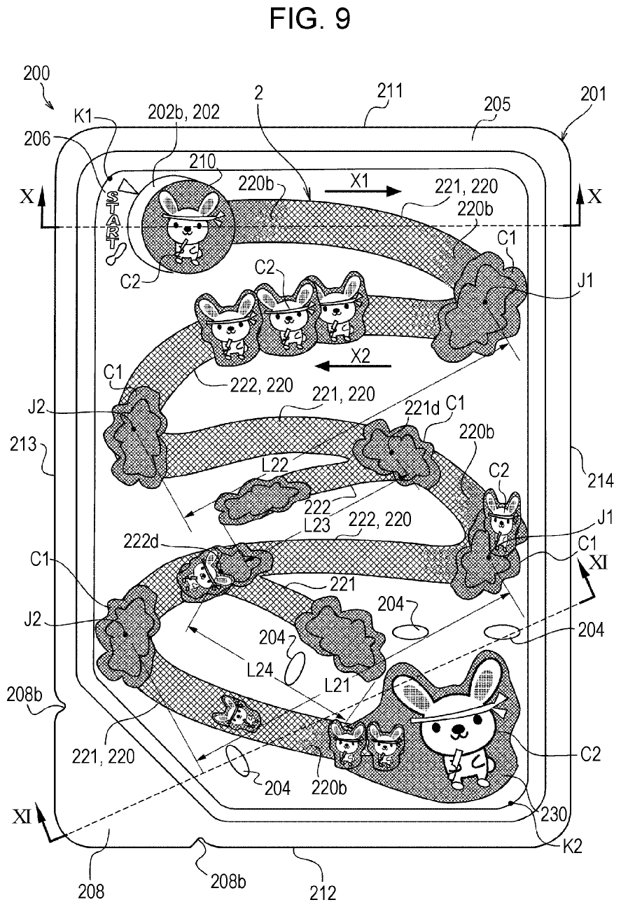

FIG. 9 is a plan view of a confection 2 according to this embodiment.

The confection 2 is a gummy candy. As shown in FIG. 9, the confection 2 and a container 201 accommodating the confection 2 form a confection set 200. When sold, the confection 2 is accommodated in the container 201 shown in FIG. 9 and is further wrapped in decoration wrapper, so that the state shown in FIG. 9 cannot be seen from the outside.

The gummy candies as referred to herein can be made of predetermined amounts of, for example, starch syrup, sugar, gelatin, concentrated fruit juice, edible oil and fat, sorbit, acidulant, thickening agent, plant-derived colorant, and flavoring.

As shown in FIG. 9, the confection 2 has a start portion 210, at which a consumer starts to extract the confection 2 from the container 201, an end portion 230, at which extraction of the confection 2 from the container 201 ends, and a long and narrow route portion 220 formed between the start portion 210 and the end portion 230. The route portion 220 includes multiple first route portions 221 extending in a first direction X1 and multiple second route portions 222 extending in a second direction X2 opposite to the first direction X1. The route portion 220 has first joint portions J1 on the right side and second joint portions J2 on the left side at which the first route portions 221 extending in the first direction X1 and the second route portions 222 extending in the second direction X2 are joined at acute angles.

For example, the first route portion 221 that is the second from the top has, in the middle thereof, a first branch portion 221d. A second route portion 222 (a second route portion 222 that ends without connecting to any route portion) extends toward the left side in FIG. 9 from the first branch portion 221d. The length (L23) of the second route portion 222 extending from the first branch portion 221d is shorter than the length (L22) of the other second route portions 222.

For example, the second route portion 222 that is the second from the top has, in the middle thereof, a second branch portion 222d. A first route portion 221 (a first route portion 221 that ends without connecting to any route portion) extends toward the right side in FIG. 9 from the second branch portion 222d. The length (L24) of the first route portion 221 extending from the second branch portion 222d is shorter than the length (L21) of the other first route portion 221.

The container 201 of the confection set 200 has a rectangular shape in plan view, including, for example, a first end 211 corresponding to the upper short side, a second end 212 corresponding to the lower short side, a third end 213 corresponding to the left long side, and a fourth end 214 corresponding to the right long side. The first direction X1 described above is a direction from the third end 213 toward the fourth end 214, and the second direction X2 is a direction from the fourth end 214 toward the third end 213.

The start portion 210 is provided near one corner K1 (upper left in FIG. 9) of the container 201 in plan view, and the end portion 230 is provided near another corner K2 (lower right in FIG. 9) that is farthest from the one corner K1.

The route portion 220 has substantially a constant width in plan view. The first joint portions J1 and the second joint portions J2, at which the first route portions 221 and the second route portions 222 are joined, have first character portions C1 in cloud shapes, for example. The first route portions 221 and the second route portions 222 have second character portions C2 somewhere therein. The start portion 210 and the end portion 230 have character portions C2 that are different from the character portions C1. The start portion 210 and the end portion 230 are larger in width than the route portion 220.

The route portion 220 has a color different from those of the start portion 210 and the end portion 230, and the route portion 220 has a taste different from those of the start portion 210 and the end portion 230. In addition, the portions having different colors are made of different ingredients. Hence, the route portion 220 has the aroma different from the aromas of the start portion 210 and the end portion 230. Furthermore, the colors of the route portion 220, the start portion 210, and the end portion 230 are mixed at connecting portions 220b. Hence, the tastes and aromas are mixed at the connecting portions 220b.

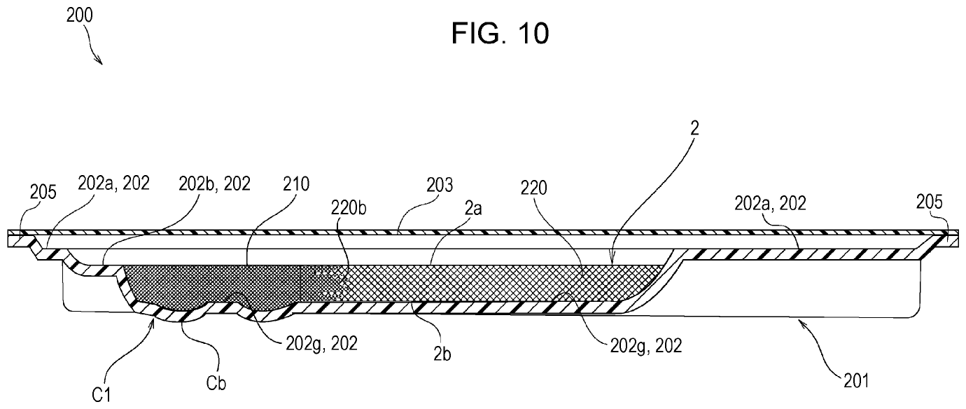

FIG. 10 is a cross-section taken along line X-X in FIG. 9.

As shown in FIG. 10, the container 201 has a rectangular cross-section taken perpendicular to a bottom surface 202 thereof. Although the characters in the character portions C1 may be illustrated in multiple colors, in this embodiment, the characters are formed with convex-and-concave portions Cb on the bottom surface 202. For example, at the character portions C2 in the start portion 210 and the end portions 230, an upper side 2a of the confection 2 is a flat surface, whereas a lower side 2b of the confection 2 is a bulging three-dimensional surface (concave/convex surface). So, the convex-and-concave portions Cb are provided at a deepest surface 202g of a bottom surface 202 of the container 201. The character portions C2 and the character portions C1 are illustrated with the convex-and-concave portions Cb.

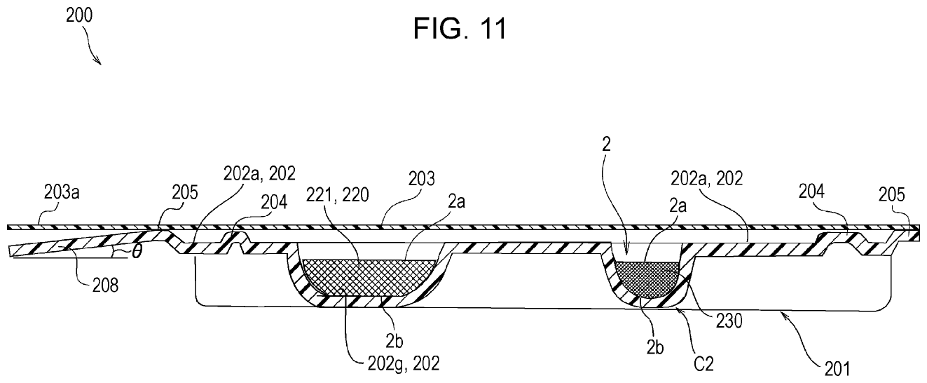

The upper side 2a of the confection 2 is formed so as not to adhere to the bottom surface 202 of the container 201 or a film lid 203. For example, at the start portion 210, the end portion 230 (see FIG. 11), and the route portion 220, the upper side 2a of the confection 2 is positioned below an upper bottom surface 202a, which is the shallowest portion of the bottom surface 202.

An outer peripheral edge 205 of the container 201 stands upright from the upper bottom surface 202a. The film lid 203 is bonded to an upper end face of the outer peripheral edge 205, at a position away from the upper bottom surface 202a in the upward direction, so as not to be in contact with the upper side 2a.

The confection 2, which is a gummy candy made of the above-described ingredients, adheres to the deepest surface 202g of the bottom surface 202 of the container 201 at all of the start portion 210, the end portion 230, and the route portion 220, in a state of being accommodated in the container 201. Furthermore, the start portion 210, the end portion 230, and the route portion 220 are all stretchable. Because the confection 2 is adhered to the deepest surface 202g of the container 201 in this way, the task of extracting the confection 2 from the container 201 is difficult. Thus, the consumer can enjoy the difficulty.

FIG. 11 is a cross-section taken along line XI-XI in FIG. 9.

As shown in FIG. 11, in the route portion 220 in cross-section, the upper side 2a, which is one side of the confection 2, is a flat surface, whereas the lower side 2b, which is the other side of the confection 2, is a curved surface.

Furthermore, projections 204 (see FIG. 9) higher than the upper bottom surface 202a and extending almost to the film lid 203 are provided on the bottom surface 202 of the container 201, at least near the end portion 230. The projections 204 are provided, for example, around the end portion 230 (see FIG. 9). This configuration makes the film lid 203 less likely to touch the upper side 2a.

The film lid 203 is bonded to the entire outer peripheral edge 205 of the container 201 accommodating the confection 2. The container 201 has, at the outer peripheral edge thereof, a film peeling portion 208 from which the consumer starts to peel away the film lid 203. The film peeling portion 208 is provided at one corner of the rectangular container 201 in plan view (see FIG. 9). The film peeling portion 208 is provided with a pair of notches 208b (see FIG. 9) at the base end thereof to indicate that the film lid 203 can be peeled from there. At the film peeling portion 208, the film lid 203 is bonded to the outer peripheral edge 205 along the base end of the film peeling portion 208, and the remainder of the film lid 203, which is not bonded to the outer peripheral edge 205, serves as a facing portion 203a that faces the film peeling portion 208.

Because the film peeling portion 208 has the notches 208b, the film peeling portion 208 is easily deformed. Furthermore, the film peeling portion 208 is inclined (at an angle θ) in a direction (downward in FIG. 11) away from the film lid 203.

With this configuration, when a consumer opens the container 201, he/she can peel away the film lid 203 by pinching the facing portion 203a, which is a film end, with fingers of one hand and pinching the film peeling portion 208 with fingers of the other hand, for example.

The task of extracting the confection 2 will be described below.

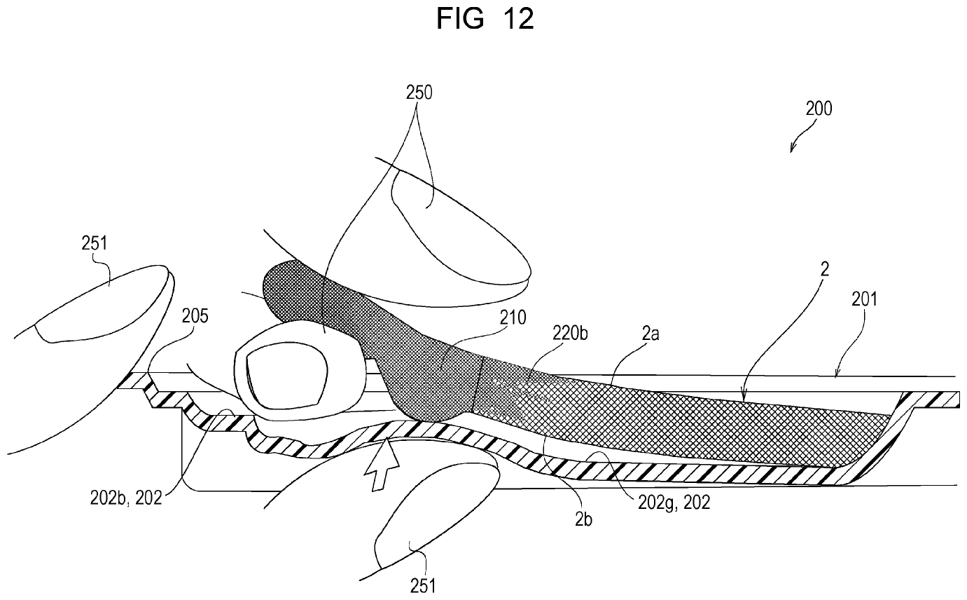

FIG. 12 is a cross-section showing an example of how to extract the start portion 210 of the confection 2.

After the film lid 203 is removed, the consumer extracts the confection 2, starting from the start portion 210 indicated by a start mark 206. The start portion 210 is provided with an intermediate bottom surface 202a, which is lower than the upper bottom surface 202b (see FIG. 10), to allow a fingertip to easily access the start portion 210.

Furthermore, the container 201 is made of a flexible soft member. Thus, for example, as shown in FIG. 12, the consumer pushes and deforms the bottom surface 202 with fingers 251 of one hand and pinches the confection 2 with fingers 250 of the other hand at the beginning of extraction.

Then, the consumer lifts, starting from the start portion 210, the confection 2 accommodated in the container 201 in a state in which the start portion 210, the end portion 230, and the route portion 220 are contracted. By doing so, the consumer can extract the confection 2 that is being stretched. At this time, the confection 2 is separated from the container 201 in the order of the start portion 210, the route portion 220, and the end portion 230. Because the confection 2 is in contact with the container 201 at the large and bulging lower side 2b, the confection 2 has high adhesion.

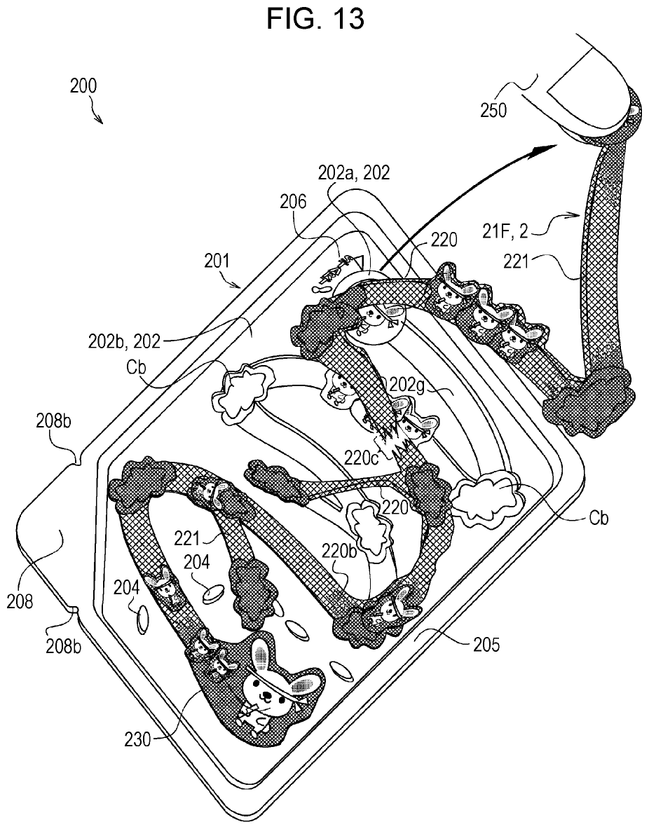

FIG. 13 is a perspective view showing an example of a first state 21F, in which the confection 2 has been torn in the play with the confection 2.

The confection 2 is formed such that it can be torn at any part when stretched to or beyond a certain length. When the confection 2 is separated from the container 201, the confection 2 can be torn at any of the start portion 210, the end portion 230, and the route portion 220. In the case shown in FIG. 13, for example, the confection 2 is torn at a tearing portion 220c upstream of the first branch portion 221d. This is because the first branch portion 221d has higher adhesion than the route portion 220 upstream thereof. In addition, because the peeling direction differs between the first and second route portions, peeling is difficult.

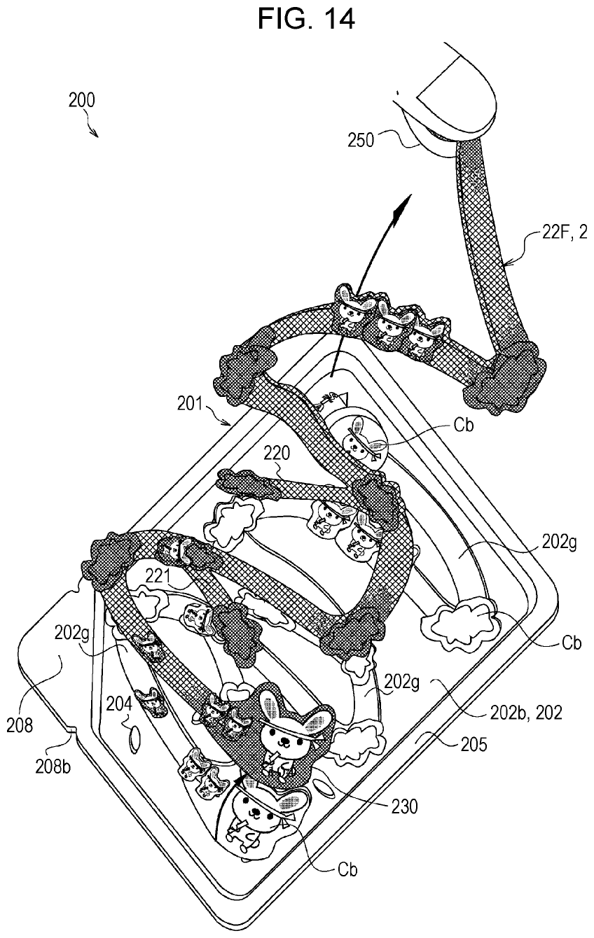

FIG. 14 is a perspective view showing a second state 22F, in which the confection 2 has not been torn in the play with the confection 2.

In the second state 22F shown in FIG. 14, the confection 2 has been successfully lifted without being torn at any part. In this case, the consumer advances peeling while managing to successfully peel the first branch portion 221d and the second branch portion 222d, which are two difficult parts. At this time, peeling of the second branch portion 222d is particularly difficult because the confection 2 has been stretched and lifted.

As described above, in the confection 2 according to this embodiment, in the route portion 220 extending from the start portion 210 to the end portion 230, the first route portions 221 extending in the first direction X1 and the second route portions 222 extending in the second direction X2, which is opposite to the first direction X1, are joined at the joint portions (the first joint portions J1 and the second joint portions J2) at acute angles. Thus, it is possible to provide the confection 2 that is easily torn. In particular, the resistance to peeling, caused when the confection 2 is peeled away from the container 201, increases the ease of tearing.

The joint portions (the first joint portions J1 and the second joint portions J2) between the first route portions 221 and the second route portions 222 include, for example, the first character portions C1 in cloud shapes, so that the joint portions have large widths (areas). This enables adjustment of the strength of the joint portions.

In the confection 2 according to this embodiment, the route portion 220 includes the first branch portion 221d and the second branch portion 222d connected to the routes extending in directions different from the peeling directions (the X1 and X2 directions) of the first branch portion 221d and the second branch portion 222d. This makes application of force that determines the peeling direction difficult. Furthermore, the lengths of the first route portion 221 and the second route portion 222 extending from the branch portion 221d and the branch portion 222d, respectively, are shorter than the lengths of the other first route portions 221 and second route portions 222 extending in the X1 and X2 directions. With this configuration, the resistance to peeling is not excessively strong.

In the confection 2 according to this embodiment, because the route portion 220 includes the character portions C2 somewhere therein, the consumer can enjoy the appearance of the route portion 220, as well as changes in taste and aroma.

In the confection 2 according to this embodiment, the container 201 has a rectangular cross-section taken perpendicular to the bottom surface 202 and is made of a flexible soft member. Thus, the container 201 can be easily deformed when the confection 2 is extracted from the container 201 starting from, for example, the start portion 210, and thus is easy to handle (allows the confection to be easily extracted).

In the confection 2 according to this embodiment, the start portion 210 is provided near one corner K1 of the container 201 in plan view, and the end portion 230 is provided near another corner K2 that is farthest from the one corner K1. Hence, the area of the container 201 can be efficiently used to form a long route portion 220.

In the confection 2 according to this embodiment, the colors of the route portion 220, the start portion 210, and the end portion 230 are mixed at the connecting portions 220b. Thus, the consumer can enjoy the mixture of colors. Furthermore, in the confection 2, when portions having different colors have different tastes, the consumer can enjoy the mixture of tastes at the connecting portions 220b. Furthermore, when portions having different colors have different aromas, the consumer can enjoy the mixture of aromas at the connecting portions 220b.

Because the color, taste, and aroma of the route portion 220 are different from those of the start portion 210 and the end portion 230, the consumer can enjoy the color, taste, and aroma corresponding to each of the route portion 220, the start portion 210, and the end portion 230. In particular, the consumer can enjoy the color, taste, and aroma associated with the character at the end portion 230.

In the confection set 200 according to this embodiment, in the route portion 220 in cross-section, the upper side 2a of the confection 2 is a flat surface, whereas the lower side 2b of the confection 2 is a curved surface. Thus, for example, the contact area between the confection 2 and the deepest surface 202g of the container 201 can be easily changed. This makes it possible to change the adhesion of the confection 2 to the container 201.

In the confection set 200 according to this embodiment, the container 201 is provided with the film lid 203 that can open and close the container 201 without coming into contact with the confection 2. Thus, the confection 2 can be protected without adhering to the film lid 203. Furthermore, the projections 204 higher than the confection 2 are provided on the bottom surface 202 of the container 201, at least near the end portion 230. Thus, contact between the film lid 203 and the upper side 2a of the confection 2 is avoided. In particular, even when the film lid 203 is removed, because the projections 204 effectively prevents the contact between the film lid 203 and the confection 2, it is possible to prevent the confection 2 from adhering to the film lid 203 and being separated from the bottom surface 202 when the film lid 203 is removed.

In the confection set 200 according to this embodiment, the confection 2 is formed such that it can be torn at any of the start portion 210, the end portion 230, and the route portion 220. Thus, the consumer can enjoy either the first state 21F, in which the confection 2 has been torn when separated from the bottom surface 202 (failure in extraction), or the second state 22F, in which the confection 2 has not been torn (success in extraction).

Although one embodiment of the present invention has been described above, the present invention can be modified as appropriate within the technical scope thereof. For example, in the above embodiment, the confection 2 has two branch portions, namely, the first branch portion 221d and the second branch portion 222d. Alternatively, one of these branch portions may be provided, or three or more branch portions may be provided.

In the above embodiment, the characters in the first character portions C1 and the second character portions C2 are not limited to those shown in the drawings.

### Third Embodiment

A confection according to an embodiment of the present invention will be described below with reference to the drawings.

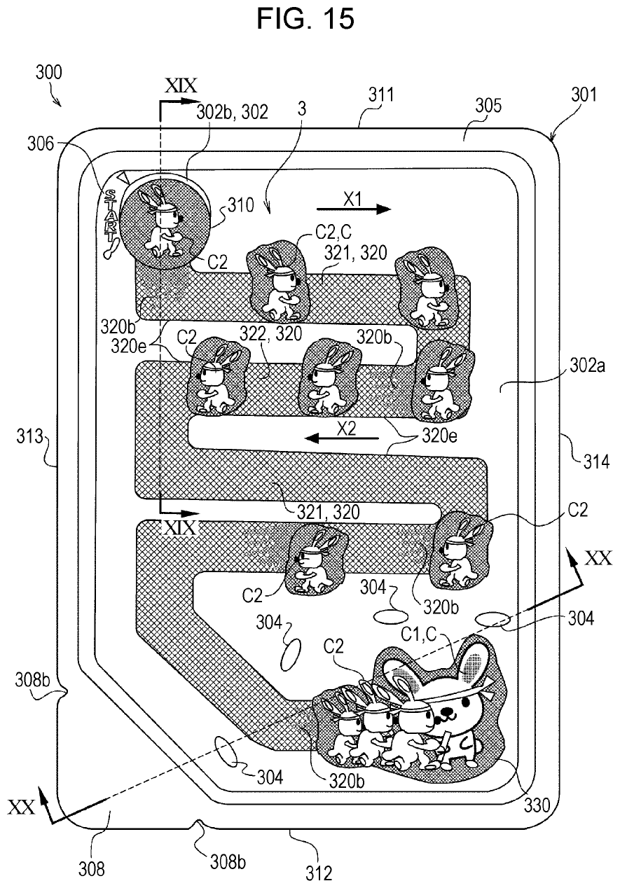

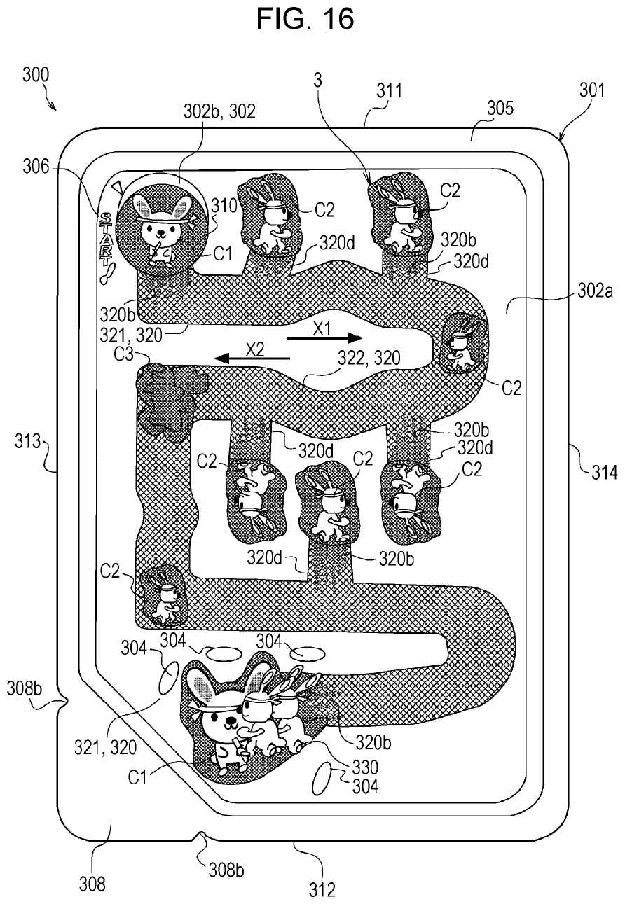

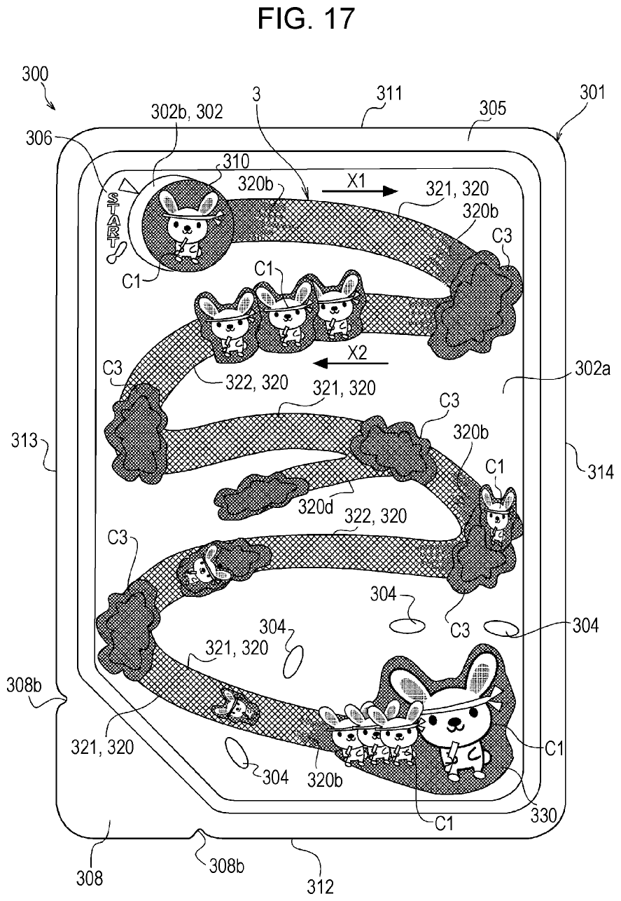

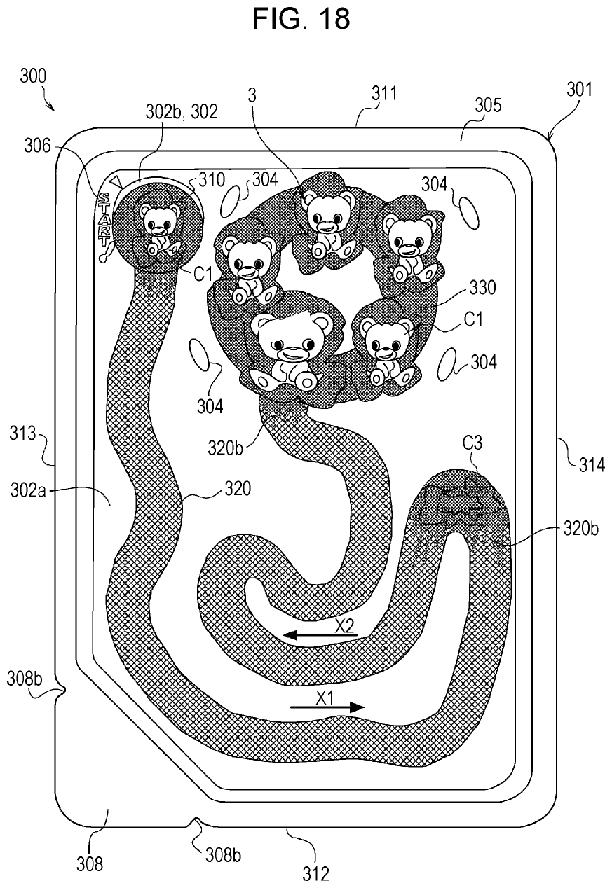

FIG. 15 is a plan view of a first form of a confection 3 according to this embodiment. FIG. 16 is a plan view of a second form of the confection 3. FIG. 17 is a plan view of a third form of the confection 3. FIG. 18 is a plan view of a fourth form of the confection 3.

The confection 3 shown in FIGS. 15 to 18 is a gummy candy. As shown in FIGS. 15 to 18, the confection 3 is sold in the form of a confection set 300, in which the confection 3 is accommodated in a container 301. When sold, the confection 3 is accommodated in the container 301 shown in FIGS. 15 to 18 and is further wrapped in decoration wrapper, so that the state shown in FIGS. 15 to 18 cannot be seen from the outside.

The container 301 of the confection set 300 has a rectangular shape in plan view, including, for example, a first end 311 corresponding to the upper short side, a second end 312 corresponding to the lower short side, a third end 313 corresponding to the left long side, and a fourth end 314 corresponding to the right long side. The confection set 300 allows a consumer to enjoy peeling and extracting the confection 3, which is a flexible and stretchable gummy candy, from the rectangular container 301, as described below.

The gummy candies as referred to herein can be made of predetermined amounts of, for example, starch syrup, sugar, gelatin, concentrated fruit juice, edible oil and fat, sorbit, acidulant, thickening agent, plant-derived colorant, and flavoring.

As shown in FIG. 15, the confection 3 has a start portion 310, at which a consumer starts to extract the confection 3 from the container 301, an end portion 330, at which extraction of the confection 3 from the container 301 ends, and a long and narrow route portion 320 having a substantially constant width and formed between the start portion 310 and the end portion 330. The route portion 320 includes multiple first route portions 321 and multiple second route portions 322. The first route portions 321 are peeled in the first direction X1 (toward the right side in FIG. 15) and the second route portions 322 are peeled in the second direction X2 opposite to the first direction X1 when the confection 3 is peeled, starting from the start portion 310. The route portion 320 forms a long route such that side ends 320e thereof in the width direction are appropriately separated from each other so as not to be in contact with each other.

In the confections 3 shown in FIGS. 15 and 16, the route portion 320 has bends. In the confection 3 shown in FIG. 17, the route portion 320 is curved at acute angles. In the confection 3 shown in FIG. 18, the route portion 320 meanders in a curved line, and the start portion 310 and the end portion 330 are located close to each other.

Furthermore, multiple types of character portions C (C1, C2, and C3), which represent the characters of the confection 3, are formed at the start portion 310, the route portion 320, and the end portion 330. For example, the character portions C1 represent animals facing the consumer, the character portions C2 represent animals facing either the left side or the right side, and the character portions C3 represent smoke or clouds. Although three types of characters are described here, the confection 3 may have more types of characters.

For example, as shown in FIGS. 15 and 16, the character portions C in the route portion 320 may be arranged at predetermined intervals in at least one of the first direction X1 and the second direction X2. Alternatively, as shown in FIG. 17, the character portions C in the route portion 320 may be lined up straight, so as to be in contact with each other without gaps. As shown in FIGS. 15 and 16, the character portions C2 on the route portion 320 include the character portions C2 on the first route portion 321, facing one direction, e.g., the right side, and the character portions C2 on the second route portion 322, facing the left side. In this way, the route portion 320 has a varying structure depending on the arrangement of the characters.

As shown in FIG. 15, in the character portion C at the end portion 330, the characters are lined up without gaps on the extension line of the route portion 320 In this way, the end portion 330 is provided with more characters and has a larger size than the other portions. Thus, the end portion 330 looks lively with these characters. Meanwhile, FIG. 18 shows a large end portion 330 in which multiple character portions C are arranged in a circle.

In the confection 3 shown in FIG. 16, some of the character portions C2 formed in the route portion 320 are provided on branch portions 320d diverged from the main route, along which the route portion 320 is peeled. For example, the confection 3 has a portion in which the character portions C2 are arranged in the left-right direction such that the character portion C2 on the first route portion 321, facing the right side, is located between the character portions C2 on the second route portion 322, facing the left side.

The route portion 320 has a color different from the color of the character portions C. Furthermore, the route portion 320 has a color different from those of the start portion 310 and the end portion 330. In addition, the portions having different colors are made of different ingredients. Hence, the route portion 320 has the aroma different from the aromas of the start portion 310 and the end portion 330. Furthermore, the colors of the route portion 320, the start portion 310, and the end portion 330 are mixed at connecting portions 320b. The tastes and aromas are mixed at the connecting portions 320b.

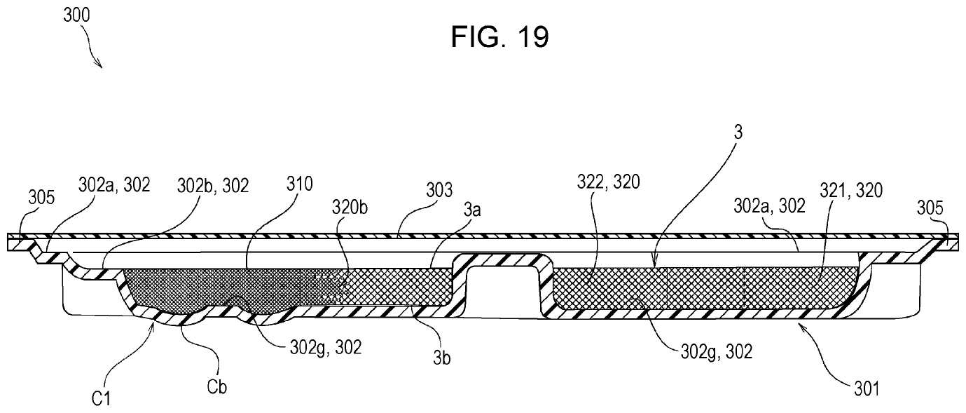

FIG. 19 is a cross-section taken along line XIX-XIX in FIG. 15.

As shown in FIG. 19, the container 301 has a rectangular cross-section taken perpendicular to a bottom surface 302 thereof. Although the characters in the character portions C may be illustrated in multiple colors, in this embodiment, the characters are formed with convex-and-concave portions Cb on the bottom surface 302. For example, at the character portions C in the start portion 310 and the end portion 330, an upper side 3a of the confection 3 is a flat surface, whereas a lower side 3b of the confection 3 is a bulging three dimensional surface (concave/convex surface). That is, on the lower side 3b, the convex-and-concave portions Cb are provided at a deepest surface 302g. The character portions C are illustrated with the convex-and-concave portions Cb.

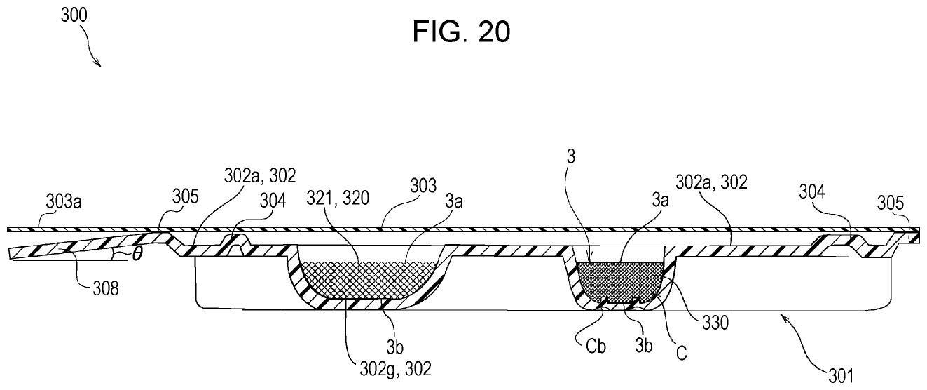

The upper side 3a of the confection 3 is formed so as not to adhere to the bottom surface 302 of the container 301 or the film lid 303. For example, at the start portion 310, the end portion 330 (see FIG. 20), and the route portion 320, the upper side 3a of the confection 3 is positioned below an upper bottom surface 302a, which is the shallowest portion of the bottom surface 302.

An outer peripheral edge 305 of the container 301 stands upright from the upper bottom surface 302a. The film lid 303 is bonded to an upper end face of the outer peripheral edge 305, at a position away from the upper bottom surface 302a in the upward direction, so as not to be in contact with the upper side 3a.

The confection 3, which is a gummy candy made of the above-described ingredients, adheres to the deepest surface 302g of the bottom surface 302 of the container 301 at all of the start portion 310, the end portion 330, and the route portion 320, in a state of being accommodated in the container 301. Furthermore, the start portion 310, the end portion 330, and the route portion 320 are all stretchable. Because the confection 3 is adhered to the bottom surface 302 of the container 301 in this way, the task of extracting the confection 3 from the container 301 is difficult. Thus, the consumer can enjoy the difficulty.

FIG. 20 is a cross-section taken along line XX-XX in FIG. 15.

As shown in FIG. 20, in the route portion 320 in cross-section, as described above, the upper side 3a, which is one side of the confection 3, is a flat surface, whereas the lower side 3b, which is the other side of the confection 3, is a curved surface.

Furthermore, projections 304 (see FIG. 15) higher than the upper bottom surface 302a and extending almost to the film lid 303 are provided on the bottom surface 302 of the container 301, at least near the end portion 330. The projections 304 are provided so as to surround the end portion 330, for example (see FIG. 15). This configuration makes the film lid 303 less likely to touch the upper side 3a.

The film lid 303 is bonded to the entire outer peripheral edge 305 of the container 301 accommodating the confection 3. The container 301 has, at the outer peripheral edge thereof, a film peeling portion 308 from which the consumer starts to peel away the film lid 303. The film peeling portion 308 is provided at one corner of the rectangular container 301 in plan view.

The film peeling portion 308 is provided with a pair of notches 308b (see FIG. 15) at the base end thereof to indicate that the film lid 303 can be peeled from there. At the film peeling portion 308, the film lid 303 is bonded to the outer peripheral edge 305 along the base end of the film peeling portion 308, and the remainder of the film lid 303, which is not bonded to the outer peripheral edge 305, serves as a facing portion 303a that faces the film peeling portion 308.

Because the film peeling portion 308 has the notches 308b, the film peeling portion 308 is easily deformed. Furthermore, the film peeling portion 308 is inclined (at an angle θ) in a direction (downward in FIG. 20) away from the film lid 303.

With this configuration, when a consumer opens the container 301, he/she can peel away the film lid 303 by pinching the facing portion 303a, which is a film end, with fingers of one hand and pinching the film peeling portion 308 with fingers of the other hand, for example.

The task of extracting the confection 3 will be described below.

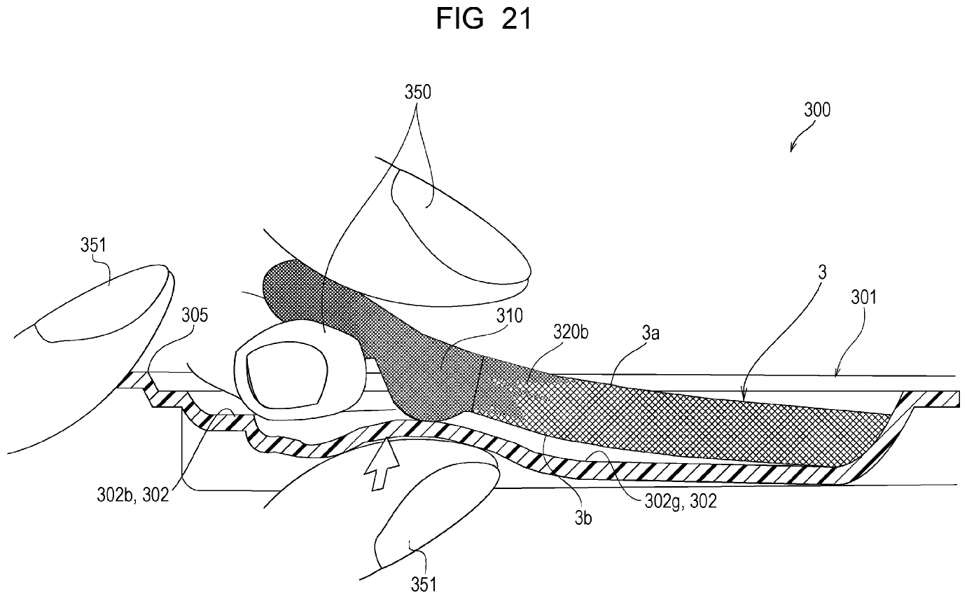

FIG. 21 is a cross-section showing an example of how to extract the start portion 310 of the confection 3.

After the film lid 303 is removed, the consumer extracts the confection 3, starting from the start portion 310 indicated by a start mark 306. The start portion 310 is provided with an intermediate bottom surface 302a, which is lower than the upper bottom surface 302b (see FIG. 15), to allow a fingertip to easily access the start portion 310.

Furthermore, the container 301 is made of a flexible soft member. Thus, for example, as shown in FIG. 21, the consumer pushes and deforms the bottom surface 302 with fingers 351 of one hand and pinches the confection 3 with fingers 350 of the other hand at the beginning of extraction.

Then, the consumer lifts, starting from the start portion 310, the confection 3 accommodated in the container 301 in a state in which the start portion 310, the end portion 330, and the route portion 320 are contracted. By doing so, the consumer can playfully extract the confection 3 that is being stretched. At this time, the confection 3 is separated from the container 301 in the order of the start portion 310, the route portion 320, and the end portion 330. Because the confection 3 is in contact with the container 301 at the large and bulging lower side 3b, the confection 3 has high adhesion.

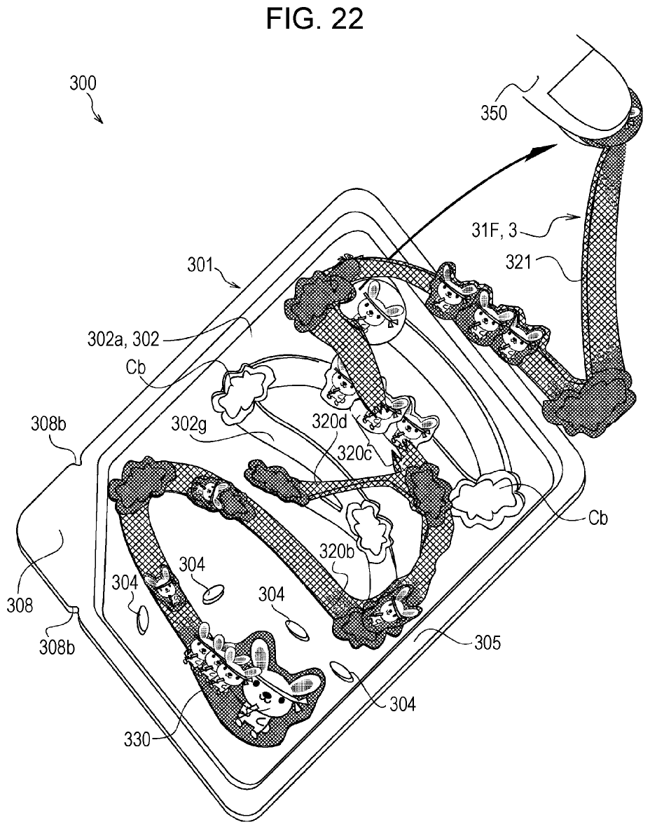

FIG. 22 is a perspective view showing an example of a first state 31F, in which the confection 3 has been torn in the play with the confection 3.

The confection 3 is formed such that it can be torn by at any part when stretched to or beyond a certain length. When the confection 3 is separated from the container 301, the confection 3 can be torn at any of the start portion 310, the end portion 330, and the route portion 320. In the first state 31F shown in FIG. 22, for example, the confection 3 has been torn at a tearing portion 320c upstream of the branch portion 320d. This is because the branch portion 320d has higher adhesion than the route portion 320 upstream thereof. Furthermore, because the peeling direction diverges at the branch portion 320d, peeling is difficult.

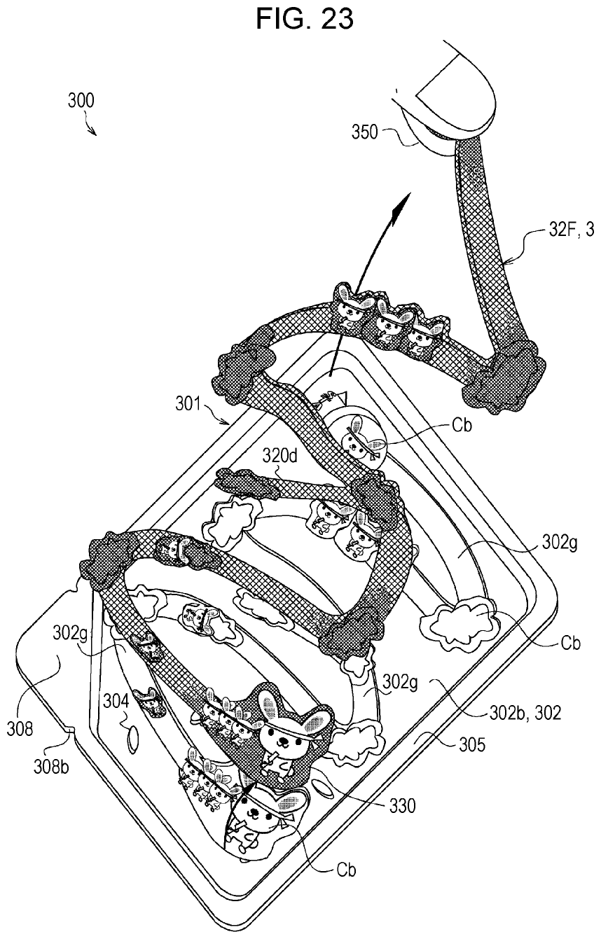

FIG. 23 is a perspective view showing a second state 32F, in which the confection 3 has not been torn in the play with the confection 3.

In the second state 32F shown in FIG. 23, the confection 3 has been successfully lifted without being torn at any part. In this case, the consumer has managed to successfully peel the branch portion 320d, which is the difficult part, and has completed peeling of the end portion 330 at the end. In the configurations shown in FIGS. 15 and 16, the route portion 320 has bends. So, peeling at such bends is difficult. In the configuration shown in FIG. 18, the route portion 320 is gently curved as a whole. So, peeling is relatively easy.

As described above, in the confection 3 according to this embodiment, at least one of the route portion 320 and the end portion 330 includes multiple character portions C. Thus, the confection 3 looks lively with these characters. Furthermore, because the portions having multiple character portions C that are arranged so as to be in contact with each other have a larger width than the route portion 320, the strength of the character portions C is high. When the character portions C are arranged in a circle, the character portions C may have various sizes. Thus, it is possible to emphasize the characters as desired.

When the character portions C are lined up straight, it is possible to indicate the direction in which the characters move, that is, for example, the peeling direction when the confection is extracted from the container. In addition, the route portion 320 is formed such that the adjacent side ends 320e thereof are not in contact with each other. Thus, the route portion 320 can be reliably separated without adjacent portions thereof sticking to each other.

In the confection 3 according to this embodiment, when the character portions C are arranged at intervals along the route portion 320, the route portion 320 has not only the varying appearance but also the varying strength, due to the presence of convex and concave portions in the character portions C, along the longitudinal direction thereof. Furthermore, because the route portion 320 includes the character portions C somewhere therein, the consumer can enjoy the appearance of the route portion 320, as well as changes in taste and aroma.

In the confection 3 according to this embodiment, because the character portions C formed in the end portion 330 are lined up without gaps, the end portion 330 has a large area.

In the confection 3 according to this embodiment, when, for example, in the route portion 320, the character portions C2 provided on the branch portions 320d extending from the first route portion 321 extending in the first direction X1 and the character portions C2 provided on the branch portions 320d extending from the second route portion 322 extending in the second direction X2 are arranged alternately and at small intervals at positions shifted from the route portion 320 (that is, when the character portions C2 are arranged in a staggered manner), the consumer can enjoy the varying peeling timing of adjacent character portions C2 (that is, the character portions C2 are peeled in an every-other fashion at different timings).

Furthermore, in the confection 3 according to this embodiment, because the characters in the plurality of character portions C are facing different directions, the consumer can enjoy the appearance of the characters. Furthermore, because the respective same character portions C, which are different from the route portion 320, have the same color, the character portions C can be easily recognized by their appearances.

In the confection 3 according to this embodiment, the character portions C at the end portion 330 are formed on the extension line of the route portion 320. Thus, peeling of the end portion 330 and a portion of the route portion 320 immediately before the end portion 330 is easy. Thus, tearing in the final stage of peeling is unlikely to occur.

In the confection 3 according to this embodiment, the container 301 has a rectangular cross-section taken perpendicular to the bottom surface 302 and is made of a flexible soft member. Thus, the container 301 can be easily deformed when the confection 3 is extracted from the container 301 starting from, for example, the start portion 310, and thus is easy to handle (allows the confection to be easily extracted).

In the confection 3 according to this embodiment, the colors of the route portion 320, the start portion 310, and the end portion 330 are mixed at the connecting portions 320b. Thus, the consumer can enjoy the mixture of colors. Furthermore, in the confection 3, when portions having different colors have different tastes, the consumer can enjoy the mixture of tastes at the connecting portions 320b. Furthermore, when portions having different colors have different aromas, the consumer can enjoy the mixture of the aromas at the connecting portions 320b.

Because the color, taste, and aroma of the route portion 320 are different from those of the start portion 310 and the end portion 330, the consumer can enjoy the color, taste, and aroma corresponding to each of the route portion 320, the start portion 310, and the end portion 330. In particular, the consumer can enjoy the color, taste, and aroma associated with the character at the end portion 330.

In the confection set 300 according to this embodiment, in the route portion 320 in cross-section, the upper side 3a of the confection 3 is a flat surface, whereas the lower side 3b of the confection 3 is a curved surface. Thus, for example, the contact area between the confection 3 and the deepest surface 302g of the container 301 can be easily changed. This makes it possible to change the adhesion of the confection 3 to the container 301.

In the confection set 300 according to this embodiment, the container 301 is provided with the film lid 303 that can open and close the container 301 without coming into contact with the confection 3. Thus, the confection 3 can be protected without adhering to the film lid 303. Furthermore, the projections 304 higher than the confection 3 are provided on the bottom surface 302 of the container 301, at least near the end portion 330. Thus, contact between the film lid 303 and the upper side 3a of the confection 3 is avoided. In particular, even when the film lid 303 is removed, because the projections 304 effectively prevents the contact between the film lid 303 and the confection 3, it is possible to prevent the confection 3 from adhering to the film lid 303 and being separated from the bottom surface 302 when the film lid 303 is removed.

In the confection set 300 according to this embodiment, the confection 3 is formed such that it can be torn at any of the start portion 310, the end portion 330, and the route portion 320. Thus, the consumer can enjoy either the first state 31F, in which the confection 3 has been torn when separated from the bottom surface 302 (failure in extraction), or the second state 32F, in which the confection 3 has not been torn (success in extraction).

Although one embodiment of the present invention has been described above, the present invention can be modified as appropriate within the technical scope thereof. For example, in the above embodiment, the character portions C1, C2, and C3 are not limited to those shown in the drawings.

As described above, the following matters are described in this specification.

(1)

A confection comprising: a start portion; an end portion; and a route portion formed between the start portion and the end portion, the route portion including a branch portion at which the route portion is split into multiple route portions, a first route portion extending from the branch portion to the end portion, and a second route portion extending from the branch portion to the end portion, wherein the end portion includes a character portion.

(2)

The confection according to (1), wherein the end portion includes one or more end portions.

(3)

The confection according to (2), wherein, when the end portion includes two or more end portions, the end portions include character portions having different shapes.

(4)

The confection according to (2), wherein, when the end portion includes one end portion, the end portion includes one character portion.

(5)

The confection according to any one of (1) to (4), wherein the first route portion and the second route portion differ in length.

(6)

The confection according to any one of (1) to (5), wherein the start portion, the end portion, and the route portion are stretchable.

(7)

The confection according to any one of (1) to (6), wherein the route portion can be stretched more than the start portion and the end portion.

(8)

The confection according to any one of (1) to (7), wherein the start portion, the end portion, and the route portion can be torn when stretched to or beyond a certain extent.

(9)

The confection according to any one of (1) to (8), wherein the route portion has a constant width in plan view.

(10)

The confection according to any one of (1) to (9), wherein the end portion has a larger surface area than the start portion.

(11)

The confection according to any one of (1) to (10), wherein the width of the route portion in plan view is smaller than the maximum width of the start portion.

(12)

The confection according to any one of (1) to (11), wherein the route portion has a color different from colors of the start portion and the end portion.

(13)

The confection according to (12), wherein the colors of the route portion, the start portion, and the end portion are mixed at connecting portions thereof.

(14)

The confection according to any one of (1) to (13), wherein the route portion has a taste different from tastes of the start portion and the end portion.

(15)

The confection according to (14), wherein the tastes of the route portion, the start portion, and the end portion are mixed at connecting portions thereof.

(16)

The confection according to any one of (1) to (15), wherein the route portion has an aroma different from aromas of the start portion and the end portion.

(17)

The confection according to (16), wherein the aromas of the route portion, the start portion, and the end portion are mixed at connecting portions thereof.

(18)

The confection according to any one of (1) to (17), wherein the route portion includes a single branch portion.

(19)

The confection according to any one of (1) to (18), wherein, in the route portion in cross-section, one side of the confection is a flat surface, and the other side of the confection is a curved surface.

(20)

The confection according to any one of (1) to (19), wherein, in the start portion and the end portion, one side of the confection is a flat surface, and the other side of the confection is a bulging three-dimensional surface.

(21)

A confection set comprising: the confection according to any one of (1) to (20); and a container configured to accommodate the confection, wherein the confection, in a state of being accommodated in the container, adheres to a bottom surface of the container.

(22)

The confection set according to (21), wherein, in the start portion, the end portion, and the route portion, one side of the confection is a flat surface, and the other side of the confection is a bulging surface, and the other side adheres to the bottom surface of the container.

(23)

The confection set according to (22), wherein, in the start portion, the end portion, and the route portion, the one side of the confection does not adhere to the bottom surface of the container.

(24)

The confection set according to any one of (21) to (23), wherein the start portion, the end portion, and the route portion are accommodated in the container in a contracted state.

(25)

The confection set according to any one of (21) to (24), wherein the route portion is accommodated in the container in a non-linear state.

(26)

The confection set according to any one of (21) to (25), wherein the route portion is accommodated in the container in a state of being curved at multiple locations.

(27)

The confection set according to any one of (21) to (26), wherein the container has a rectangular shape in plan view, and the length of the confection from the start portion to the end portion in a stretched state is larger than the length of the long sides of the container.

(28)

The confection set according to any one of (21) to (27), wherein the confection is separable from the container in the order of the start portion, the route portion, and the end portion.

(29)

The confection set according to any one of (21) to (28), wherein the container is provided with a film lid that can open and close the container without coming into contact with the confection adhered to the bottom surface.

(30)

The confection set according to any one of (21) to (29), wherein the container has, at an outer peripheral edge thereof, a film peeling portion inclined in a direction away from the film lid.

(31)

The confection set according to any one of (21) to (30), wherein a projection higher than the confection is provided on a bottom surface of the container, at least near the end portion.

(32)

The confection set according to any one of (21) to (31), wherein the confection is brought into either a first state in which the confection has been torn at any of the start portion, the end portion, and the route portion or a second state in which the confection has not been torn at any of the start portion, the end portion, and the route portion when the confection is separated from the container.

(1)

A confection comprising: a start portion; an end portion; and a route portion formed between the start portion and the end portion, the route portion including a first route portion extending in a first direction, a second route portion extending in a second direction, and a joint portion at which the first route portion and the second route portion are joined at an acute angle.

(2)

The confection according to (1), wherein the first direction is opposite to the second direction.

(3)

The confection according to (1) or (2), wherein the first route portion includes a plurality of first route portions, and the second route portion includes a plurality of second route portions.

(4)

The confection according to any one of (1) to (3), wherein the joint portion between the first route portion and the second route portion includes a first character portion.

(5)

The confection according to any one of (1) to (4), wherein the first route portion includes a first branch portion and is joined to the second route portion via the first branch portion.

(6)

The confection according to (5), wherein the second route portion extending from the first branch portion is shorter than the other second route portion.

(7)

The confection according to (5) or (6), wherein the second route portion includes a second branch portion and is joined to the first route portion via the second branch portion.

(8)

The confection according to (7), wherein the first route portion extending from the second branch portion is shorter than the other first route portion.

(9)

The confection according to (7) or (8), wherein the first branch portion is provided in the middle of the first route portion, and the second branch portion is provided in the middle of the second route portion.

(10)

The confection according to any one of (1) to (9), wherein the first route portion and the second route portion include a second character portion somewhere therein.

(11)

The confection according to (10), wherein the second character portion, the start portion, and the end portion have colors different from a color of the other portion.

(12)

The confection according to (10) or (11), wherein the second character portion, the start portion, and the end portion have tastes different from a taste of the other portion.

(13)

The confection according to any one of (10) to (12), wherein the second character portion, the start portion, and the end portion have aromas different from an aroma of the other portion.

(14)

The confection according to any one of (1) to (13), wherein, in the route portion in cross-section, one side of the confection is a flat surface, and the other side of the confection is a curved surface.

(15)

The confection according to any one of (1) to (14), wherein, in the start portion and the end portion, one side of the confection is a flat surface, and the other side of the confection is a bulging three-dimensional surface.

(16)

A confection set comprising: the confection according to any one of (1) to (15); and a container configured to accommodate the confection, wherein the confection, in a state of being accommodated in the container, adheres to a bottom surface of the container.

(17)

The confection set according to (16), wherein the container is made of a flexible soft member and has a rectangular cross-section taken perpendicular to the bottom surface.

(18)

The confection set according to (16) or (17), wherein the start portion is provided near one corner of the container in plan view, and the end portion is provided near another corner different from the one corner.

(19)

The confection set according to any one of (16) to (18), wherein, in the start portion, the end portion, and the route portion, one side of the confection is a flat surface, and the other side of the confection is a bulging surface, and the other side adheres to the bottom surface of the container.

(20)

The confection set according to any one of (16) to (19), wherein the container has a rectangular shape including a first end corresponding to one short side, a second end corresponding to the other short side, a third end corresponding to one long side, and a fourth end corresponding to the other long side, and the first direction is a direction from the third end toward the fourth end, and the second direction is a direction from the fourth end toward the third end.

(21)

The confection set according to any one of (16) to (20), wherein the confection is separable from the container in the order of the start portion, the route portion, and the end portion.

(22)

The confection set according to any one of (16) to (21), wherein the container is provided with a film lid that can open and close the container without coming into contact with the confection adhered to the bottom surface.

(23)

The confection set according to any one of (16) to (22), wherein a projection higher than the confection is provided on a bottom surface of the container, at least near the end portion.

(24)

The confection set according to any one of (16) to (23), wherein the confection is brought into either a first state in which the confection has been torn at any of the start portion, the end portion, and the route portion or a second state in which the confection has not been torn at any of the start portion, the end portion, and the route portion when the confection is separated from the container.

(1)

A confection comprising: a start portion; an end portion; and a route portion formed between the start portion and the end portion, wherein at least one of the route portion and the end portion includes a plurality of character portions.

(2)

The confection according to (1), wherein the character portions are arranged in a certain manner.

(3)

The confection according to (1) or (2), wherein the character portions are arranged so as to be in contact with each other.

(4)

The confection according to any one of (1) to (3), wherein the character portions are lined up straight.

(5)

The confection according to any one of (1) to (3), wherein the character portions are arranged in a circle.

(6)

The confection according to any one of (1) to (5), wherein the character portions have the same color.

(7)

The confection according to any one of (1) to (6), wherein the character portions have a color different from the color of the route portion.

(8)

The confection according to (1) or (2), wherein the character portions formed in the route portion are arranged at intervals.

(9)

The confection according to any one of (1) to (8), wherein the character portions formed in the end portion are arranged without gaps.

(10)

The confection according to any one of (1) to (9), wherein the route portion includes a first route portion extending in a first direction and a second route portion extending in a second direction.

(11)

The confection according to (10), wherein the character portions formed in the first route portion and the character portions formed in the second route portion are arranged in a certain manner.

(12)

The confection according to (10) or (11), wherein the character portions are arranged in at least one of the first direction and the second direction.

(13)

The confection according to any one of (1) to (12), wherein the character portions formed in the route portion are located at at least one of positions in the route portion and positions not in the route portion.

(14)

The confection according to any one of (1) to (13), wherein the character portions formed in the end portion are formed on an extension line of the route portion.

(15)

The confection according to any one of (1) to (14), wherein the route portion includes side ends that are formed so as not to be in contact with each other.

(16)

The confection according to any one of (1) to (15), wherein the plurality of character portions include a character portion facing one direction and a character portion facing another direction different from the one direction.

(17)

A confection set comprising: the confection according to any one of (1) to (16); and a container configured to accommodate the confection, wherein the confection, in a state of being accommodated in the container, adheres to a bottom surface of the container.

(18)

The confection set according to (17), wherein the container is made of a flexible soft member and has a rectangular cross-section taken perpendicular to the bottom surface.

(19)

The confection set according to (17) or (18), wherein, in the start portion, the end portion, and the route portion, one side of the confection is a flat surface, and the other side of the confection is a bulging surface, and the other side adheres to the bottom surface of the container.

(20)

The confection set according to any one of (17) to (19), wherein the confection is separable from the container in the order of the start portion, the route portion, and the end portion.

(21)

The confection set according to any one of (17) to (20), wherein the container is provided with a film lid that can open and close the container without coming into contact with the confection adhered to the bottom surface.

(22)

The confection set according to any one of (17) to (21), wherein a projection higher than the confection is provided on a bottom surface of the container, at least near the end portion.

(23)

The confection set according to any one of (17) to (22), wherein the confection is brought into either a first state in which the confection has been torn at any of the start portion, the end portion, and the route portion or a second state in which the confection has not been torn at any of the start portion, the end portion, and the route portion when the confection is separated from the container.

What is claimed is:

1. A confection comprising:
a start portion;
an end portion; and
a route portion formed between the start portion and the end portion, the route portion including a branch portion at which the route portion is split into multiple route portions, a first route portion extending from the branch portion to the end portion, and a second route portion extending from the branch portion to the end portion,
wherein the end portion includes a character portion.

2. The confection according to claim 1, wherein, when the end portion includes two or more end portions, the end portions include character portions having different shapes.

3. The confection according to claim 1, wherein the first route portion and the second route portion differ in length.

4. The confection according to claim 3, wherein the start portion, the end portion, and the route portion are stretchable.

5. The confection according to claim 4, wherein the route portion can be stretched more than the start portion and the end portion.

6. The confection according to claim 5, wherein the start portion, the end portion, and the route portion can be torn when stretched to or beyond a certain extent.

7. The confection according to claim 1, wherein the route portion has a constant width in plan view.

8. The confection according to claim 1, wherein the end portion has a larger surface area than the start portion.

9. The confection according to claim 8, wherein the width of the route portion in plan view is smaller than the maximum width of the start portion.

10. The confection according to claim 1, wherein, in the route portion in cross-section, one side of the confection is a flat surface, and the other side of the confection is a curved surface.

11. The confection according to claim 10, wherein, in the start portion and the end portion, one side of the confection is a flat surface, and the other side of the confection is a bulging three-dimensional surface.

12. A confection set comprising:
the confection according to claim 1; and
a container configured to accommodate the confection,
wherein the confection, in a state of being accommodated in the container, adheres to a bottom surface of the container.

13. The confection set according to claim 12, wherein, in the start portion, the end portion, and the route portion, one side of the confection is a flat surface, and the other side of the confection is a bulging surface, and the other side adheres to the bottom surface of the container.

14. The confection set according to claim 12, wherein the start portion, the end portion, and the route portion are accommodated in the container in a contracted state.

15. The confection set according to claim 14, wherein the route portion is accommodated in the container in a non-linear state.

16. The confection set according to claim 14, wherein the route portion is accommodated in the container in a state of being curved at multiple locations.

17. The confection set according to claim 12, wherein the container has a rectangular shape in plan view, and the length of the confection from the start portion to the end portion in a stretched state is larger than the length of the long sides of the container.

18. The confection set according to claim 12, wherein the confection is brought into either a first state in which the confection has been torn at any of the start portion, the end portion, and the route portion or a second state in which the confection has not been torn at any of the start portion, the end portion, and the route portion when the confection is separated from the container.

19. A confection comprising:
a start portion;
an end portion;
and a route portion formed between the start portion and the end portion, the route portion including a first route portion extending in a first direction, a second route portion extending in a second direction, and a joint portion at which the first route portion and the second route portion are joined at an acute angle.

20. The confection according to claim 19, wherein the joint portion between the first route portion and the second route portion includes a first character portion.

21. A confection comprising:
a start portion;
an end portion;
and a route portion formed between the start portion and the end portion,
wherein at least one of the route portion and the end portion includes a plurality of character portions.

22. The confection according to claim 21, wherein the character portions are in at least one of a state of being arranged in a certain manner, a state of being in contact with each other, and a state of being lined up straight.
